(19) United States
(12) Patent Application Publication
(10) Pub. No.: US 2026/0054581 A1
(43) Pub. Date: Feb. 26, 2026

(54) RECHARGEABLE BATTERY CHARGING CABLE DISCONNECT SYSTEMS AND METHODS OF OPERATING THEREOF

(71) Applicant: Kubota Corporation, Osaka (JP)

(72) Inventors: David Joseph Kelly, Mesa, AZ (US); Jonathan Louis Baker, Chandler, AZ (US)

(21) Appl. No.: 19/309,504

(22) Filed: Aug. 25, 2025

Related U.S. Application Data
(60) Provisional application No. 63/687,228, filed on Aug. 26, 2024.

(51) Int. Cl. B60L 53/16

(52) U.S. Cl. CPC B60L 53/16; B60L 2270/20

(57) ABSTRACT

Some embodiments may include an apparatus operable with a charging station or system comprising a rechargeable battery or other power source; the apparatus including a charging inlet or port and a housing defining a receptacle for a charging cable and its plug. The apparatus includes a retaining mechanism moveable between a disengaged state allowing the plug of the charging cable to be electrically isolated while in the receptacle and an engaged state allowing the plug of the charging cable to be engaged with the charging inlet.

### CROSS-REFERENCE TO RELATED APPLICATIONS

This application claims the benefit of and priority to U.S. Provisional Patent Application No. 63/687,228 filed Aug. 26, 2024 and entitled “RECHARGEABLE BATTERY CHARGE CABLE DISCONNECT SYSTEM,” which is hereby incorporated by reference in its entirety.

### TECHNICAL FIELD

The present disclosure relates generally to charging systems including those involving electric vehicles and other devices that utilize battery or other power source recharging for use.

### BACKGROUND

Electric vehicles rely on battery systems that must be periodically recharged from an external power source. This process involves connecting such a battery to external equipment that delivers electrical energy to the battery of the vehicle via a cable interface. In the context of a vehicle battery system, the external equipment may be referred to as electric vehicle supply equipment (EVSE) or simply, charging systems or stations. There are a variety of batteries and a variety of charging systems. Given the variety in infrastructure, communication between systems may have varying levels of compatibility. Standards such as SAE J1772, which provides for North American standards for electrical connectors for electric vehicles, U.S. Department of Energy Alternative Fuels Data Center (https://afdc.energy.gov/fuels/electricity-stations), and like resources describe some vehicle charging systems' interoperability.

Common examples of electric vehicle charge connectors or plugs—the interface at the end of the charge cable that physically connects to the vehicle's charging port—are shown in FIG. 1. The table of FIG. 1 illustrates various electric vehicle charge connectors by charger type and speed. For example, Level 1 is an SAE J1772 connector providing charging through a common 120V AC outlet; Level 2—an SAE J1772 connector providing higher-rate AC charging through 240V (in residential applications) or 208V (in commercial applications); and Direct Current Fast Charging (DCFC) connectors offers rapid charging at installed stations. Additional information regarding the electric vehicle charge connectors can be found in the Charging Standard SAE J1772, which is hereby incorporated by reference in its entirety (available at: https://www.sac.org/sae-j1772-electric-vehicle-adapter-and-plug-standardhttps://www.sac.org/sae-j1772-electric-vehicle-adapter-and-plug-standard).

Typically, it is desired to introduce high voltages and/or high currents to shorten battery charge times. Exemplary electric vehicle chargers shown in FIG. 1 illustrate delivery of power up to about 350 KW with voltages of about 1000 VDC. These high voltages and/or high currents can be dangerous if proper control of the infrastructure is not provided; in particular, risks may develop if system failures are not appropriately detected and sufficiently and efficiently addressed. Charging system failures or charging faults could expose users, vehicles and charging stations to dangerous conditions, such as electrocution, lethal voltages, rapid cable heating due to cable faults or uncontrolled current levels, rapid battery heating resulting in battery fires, exposed high voltages at the charge connector if charging shutoff fails, charge cable degradation (e.g., due to use, wear, and/or intentional damage), and/or other safety concerns.

Challenges remain in ensuring safe and efficient connections between different types of batteries and different charging systems. Furthermore, existing systems may lack sufficient detection and control mechanisms that monitor and address charging conditions to adequately mitigate risks.

### SUMMARY

Exemplary embodiments indicate the application of certain charging techniques. However, various features described herein can be applied to any charge connection technique, now known (such as the connector types referenced in the background section) or later developed. The various features and embodiments are not restricted to a specific charging connector type. Further, the various features and embodiments can be easily applied to any type or function of electrically connected charging system, including various vehicles and other components including, but not limited to, power tools, accessories, or any other rechargeable power source applications.

Battery charging systems may have various fault sensing mechanisms. If fault conditions such as a charge regulation failure, excessive battery heating, an overcurrent condition, an overvoltage condition, or ground-fault are detected, a risk to the system may be present (e.g., electrocution, fire or system damage). In some implementations discussed herein, a charging cable is configured to electrically disconnect on a fault recognized in the battery, the associated charging features of the charging vehicle (e.g., vehicle charging port, on-board charger, battery management system), the charging station, the charging cable or connector, or combinations thereof. In an embodiment, a mechanism for automatically disconnecting the charging cable in case of a recognized fault (e.g., a fault detected by fault sensing) is provided. Certain embodiments of the system(s) and method(s) described may be configured to be electrically disconnect and, in some cases, physically retain the charging cable when such faults are sensed.

As discussed in detail below, in some implementations, after the charging cable is disconnected on a fault detection, physical retention of the charging cable is provided. In some embodiments, the physical retention is implemented when a fault allows the charging cable to remain energized. By physically retaining the energized charging cable, a risk of damage from the still-energized cable making undesired contact with the surrounding environment (e.g., with the user, water or wet ground surrounding the system) may be mitigated. Other benefits may also be appreciated. For example, if the charge accepting system (e.g., vehicle) fails to detect overcharging conditions, the battery being charged could overheat and cause damage or fire. Charging cable disconnection and retention can mitigate such a risk. Other faults such as cable or connector damage or other localized heating or current or voltage leakage could also initiate the disconnection and/or the disconnection and retention of the charging cable.

### BRIEF DESCRIPTION OF THE DRAWINGS

FIG. 1 is a table showing common examples of known electric vehicle chargers.

FIG. 2 is a schematic view of a charging system, according to various embodiments.

FIG. 3A is a schematic view of a rechargeable battery charging cable disconnect system in which a power plug is connected, according to various embodiments.

FIG. 3B is a schematic view of the rechargeable battery charging cable disconnect system of FIG. 3A in which a power plug is disconnected, according to various embodiments.

FIGS. 4A-4F illustrate a rechargeable battery charging cable disconnect system, such as the rechargeable battery charge cable of FIGS. 3A and 3B, at various states, according to various embodiments.

FIG. 5 is a flowchart of a method of disconnecting and/or retaining the charging cable, according to some embodiments.

### DETAILED DESCRIPTION

As used in this application and in the claims, the singular forms “a,” “an,” and “the” include the plural forms unless the context clearly dictates otherwise. Additionally, the term “includes” means “comprises.” Further, the term “coupled” does not exclude the presence of intermediate elements between the coupled items. The systems, apparatus, and methods described herein should not be construed as limiting in any way. Instead, the present disclosure is directed toward all novel and non-obvious features and aspects of the various disclosed embodiments, alone and in various combinations and sub-combinations with one another. The term “or” refers to “and/or,” not “exclusive or” (unless specifically indicated).

The disclosed systems, methods, and apparatuses are not limited to any specific aspect or feature or combinations thereof, nor do the disclosed systems, methods, and apparatuses require that any one or more specific advantages be present or problems be solved. Any theories of operation are to facilitate explanation, but the disclosed systems, methods, and apparatus are not limited to such theories of operation. Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed systems, methods, and apparatus can be used in conjunction with other systems, methods, and apparatus.

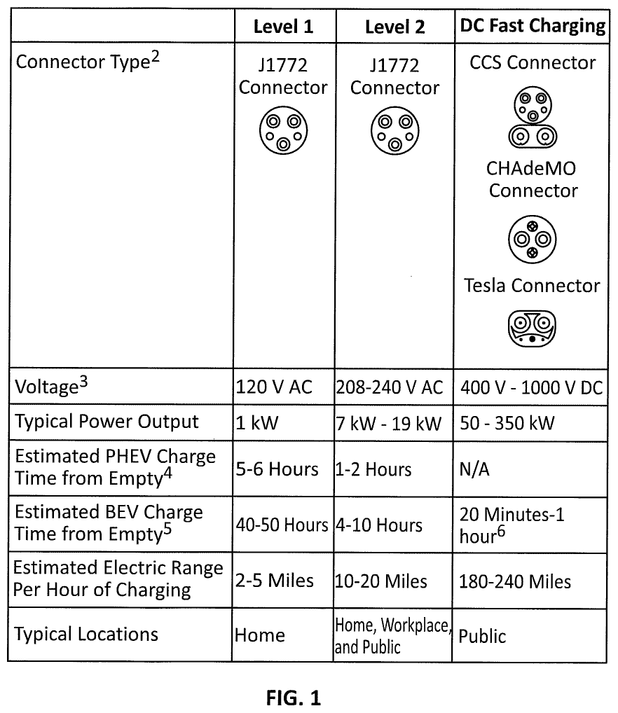

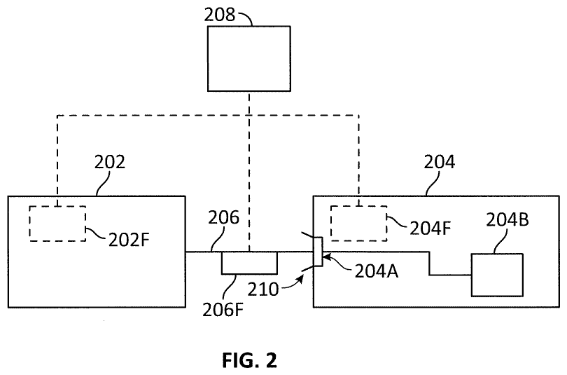

Referring to FIG. 2, illustrated is an embodiment of a charging system 200 according to some aspects of the present disclosure. The charging system 200 includes a charging station 202 and a battery-including apparatus 204 operable to receive an electrical charge from the charging station 202 for charging its rechargeable battery 204B. The charging station 202 and the apparatus 204 are connected by a charging cable 206 attached at a charging port or inlet 204A of the apparatus 204 to provide physical and electrical coupling to the charging station 202. The apparatus 204 may be a vehicle such as a car, a truck, a bus, a tractor, construction equipment, or other vehicle type, a power tool, or similar rechargeable battery or other rechargeable power source comprising apparatus. The charging system 200 may implement one or more of the charging techniques of FIG. 1, or another charging technique.

The charging station 202, the apparatus 204, and/or the charging cable 206 may include a fault detection mechanisms 202F, 204F, and 206F respectively. In some implementations one or more of the fault detection mechanisms are omitted (e.g., the charging cable 206 may not include a fault detection mechanism 206F). In an embodiment, the fault detection mechanism(s) may be operably coupled to a controller 208 associated with the system 200. The controller 208 may be physically located in a computer system within any one of the elements of the system 200 or a remote system.

The controller 208 in the system 200 may comprise a processor, a memory, and a communication interface. In some embodiments, the controller 208 may include other components not shown. The controller 208 may comprise processing circuitry operable to control the operations and performance of a general purpose processor or other circuitry. In some embodiments, at least one non-transitory computer-readable storage medium is provided having computer-executable instructions embodied thereon, wherein, when executed by at least one processor, the computer-executable instructions cause the processor to perform embodiments of the methods described herein. This computer-readable storage medium can be embodied in a memory of the controller. In some embodiments, the memory may comprise any machine-readable or computer-readable media capable of storing data. The non-volatile memory unit is capable of storing one or more software programs. The software programs may contain, for example, fault identifications, fault data, configuration data of the charging cable, or combinations therefore, to name only a few. The software programs may contain instructions executable by the various components of the controller. In one embodiment, the memory of the controller may contain an instruction set, in the form of a file for executing a method of receiving a fault detection and providing an instruction to release and/or retain the charging cable in response to the received fault detection.

In some embodiments, the controller 208 includes a communications interface may comprise any suitable hardware, software, or combination of hardware and software that is capable of coupling the controller 208 of the system 200 to one or more networks and/or additional devices. The communications interface may be arranged to operate with any suitable technique for controlling information signals using a desired set of communications protocols, services or operating procedures. The communications interface may comprise the appropriate physical connectors to connect with a corresponding communications medium, whether wired or wireless. The communication interface may provide an alert to a user of the fault mechanism identified and/or an indication that the charging cable has been released and/or retained. The controller 208 may indicate faults to the user of the charging system such as an indicator light and/or audible alarm, messaging from the charger and/or unit being charged, and/or to a user's device or charged device of apparatus 204 and/or charging system 202.

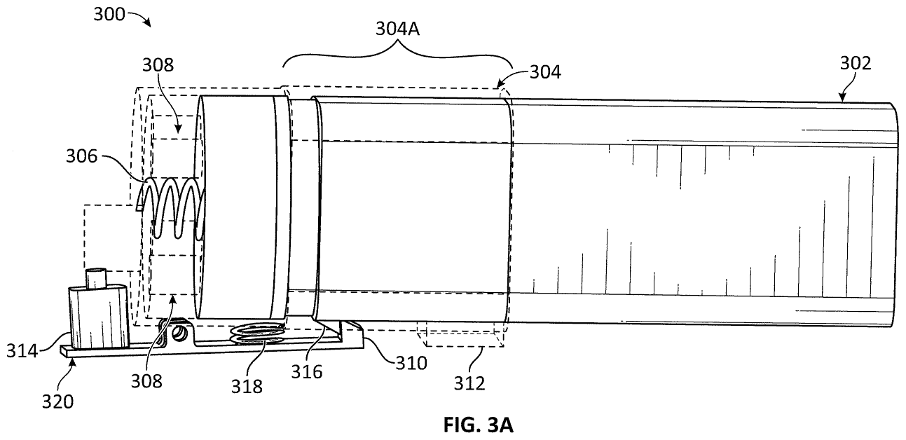

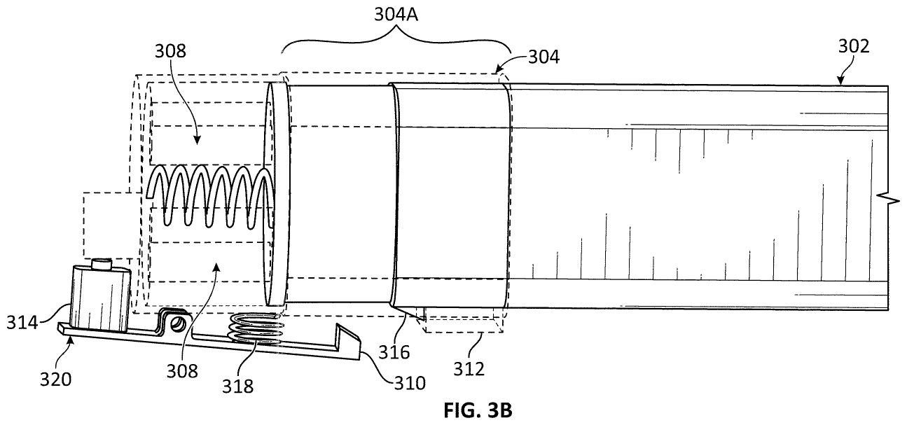

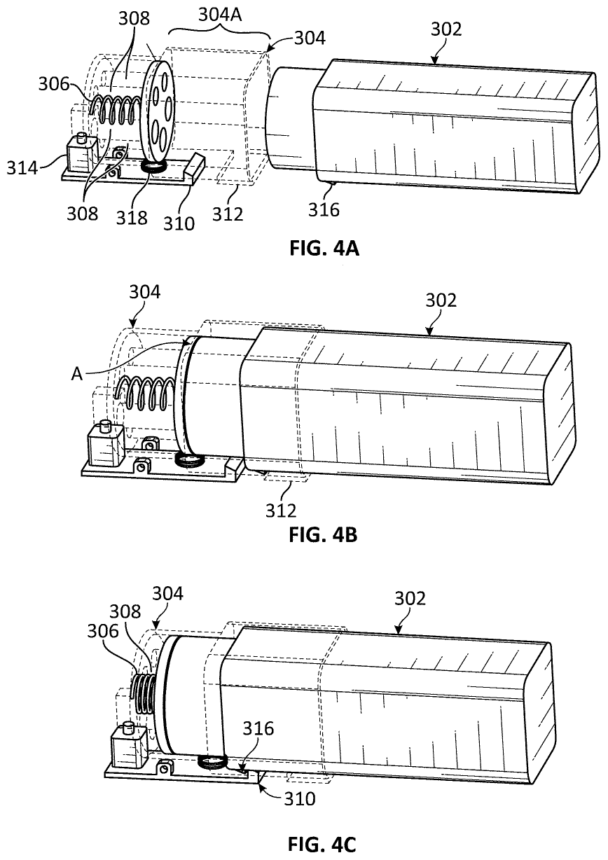

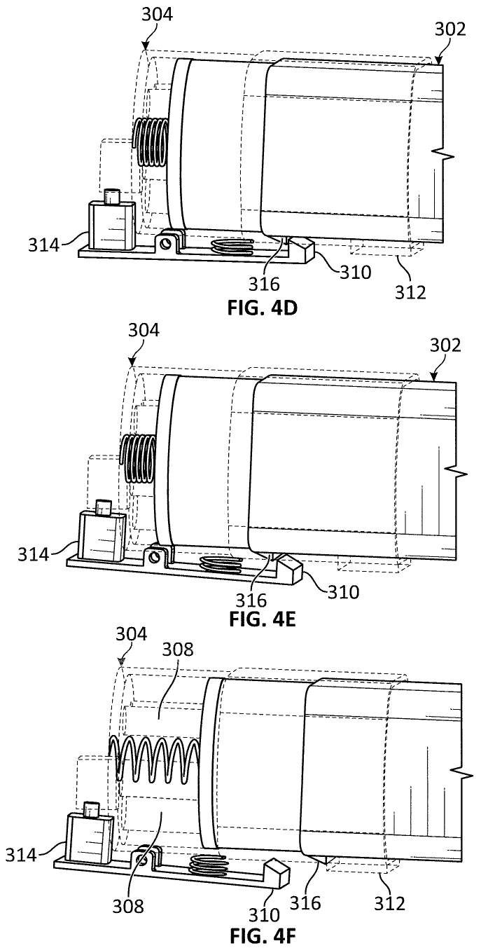

In some implementations, the controller 208 may also be operably coupled to a charging cable release and retention mechanism 210 (also referred to herein as an ejection-retention assembly). In the illustrated embodiment, the cable release and retention mechanism 210 is associated with the charging inlet or port 204A on the apparatus 204 for receiving the charging cable 206. That is the charging inlet 204A is dimensioned to be compatible for receipt of a charging plug of the charging cable 206. The charging cable release and retention mechanism 210 may be substantially similar to one or more of the embodiments discussed below including with reference to FIGS. 3A, 3B, and 4A-4F. In some implementations, the controller 208 receives an indication of a fault from one or more of the fault detection mechanisms 202F, 204F or 206F and conveys instructions to the cable release and retention mechanism 210. The instructions may be to release and/or retain the charging cable 206 in response to the detected fault. The controller 208 may also provide an indication of the fault to a user interface.

In some embodiments, a mechanical, electrical, thermal or other release mechanism of the charging cable release and retention mechanism 210 provides to physically disconnect or disengage the charging cable 206 from charging inlet 204A on the apparatus 204 such that there is no longer electrical coupling. In some embodiments, the release mechanism provides for a release or unlocking of a primary retaining mechanism. In some embodiments, a secondary retaining mechanism of the charging cable release and retention mechanism 210 provides to physically retain the charging cable after the disconnection or disengagement provided by the unlocking of the primary retaining mechanism.

In that regard, various embodiments of the system 200 may include one or more of the following aspects to perform the functions of the cable release and retention mechanism 210, which are discussed in further detail herein. In an embodiment, the charging cable 206 is positioned in the cable release and retention mechanism 210 that includes a housing forming a receptacle for the charging cable 206. The receptacle may include a collar, a sleeve, a rail, an angled guide sleeve or other mechanical charging cable plug retention system that holds the charging cable 206 before, after and/or during its connection with the inlet 204A of apparatus 204.

The system 200 may include the charging cable release and retention mechanism 210 having a primary retaining mechanism or lock that retains and/or secures the charging cable 206 when it is delivering a charge to or is otherwise electrically connected to the apparatus 204 thereby providing coupling of the apparatus 204 and the charging station 202. The primary retaining mechanism may be referred to as a lock and be implemented in various ways including a latch as detailed in FIGS. 3A and 3B. The primary retaining mechanism secures the charging cable 206 in a first position or stage, the first stage being an active charging position.

The charging cable release and retention mechanism 210 of the system 200 may further include a secondary retaining mechanism or lock that physically retains the charging cable 206 when it is not electrically connected to the apparatus 204, but is positioned adjacent thereto and secured from contact with the environment (e.g., ground, user). In some embodiments, the charging cable 206 is retained within a receptacle (e.g., collar, sleeve, rail or other mechanical charging cable plug retention system of the charging cable release and retention mechanism 210) by the secondary retaining mechanism. In an implementation, maintaining the charging cable 206 within the receptacle by the secondary retention retaining prevents the released charging cable 206 from being physically ejected from apparatus 204—the unit being charged. These features are discussed in further detail below with reference to FIGS. 3A, 3B, 4A-4F.

In an embodiment, the charging cable release and retention mechanism 210 may further include a mechanical release mechanism that allows a user to remove the plug of the charging cable 206 from the receptacle by releasing the second retention mechanism.

It is noted that the discussion of FIG. 2 illustrates as an example the cable release and retention mechanism 210 being associated with the apparatus 204, that apparatus comprising the battery or other power source receiving the charge. However, in other embodiments, the cable release and retention mechanism 210 is associated with the charging station 202. This may be implemented when using an untethered charging station as charging station 202. In other embodiments, a cable release and retention mechanism 210 may be associated with each of the charging station 202 and the apparatus 204.

In an embodiment, the first retention mechanism is a latch that is operably coupled to an actuator to move the latch between lock and unlock positions. The actuator may be any release mechanism such as mechanical actuator, an electrical solenoid or motor, a thermal bimetal, an electrically powered actuator, and/or other suitable feature. In an embodiment, the second retention mechanism is a protrusion (e.g., into the receptacle) that secures the charging cable 206. The charging inlet 204A (or similarly configured socket located on charging station 202) and/or plug of the charging cable 206 may have another type of dual retention system or a motorized two stop retention-ejection drive that retains the charging cable 206 after it is electrically disconnected. This is to prevent the charging cable 206 from being forcibly ejected when a fault keeps the charge system activated to prevent electrical shock or fire risk.

As discussed above, the system 200 includes one or more mechanisms to detect charging faults. A fault monitoring system such as fault detection mechanisms 202F, 204F and/or 206F can connect to and monitor current charging system diagnostics or employ non-contact methods such as, but not limited to, thermal and/or inductive current monitoring. The fault detection system(s) may be in communication with a charging station 202, apparatus 204 and/or charging cable 206 using RF or a contacting system that is connected to the charge plug communication port or may include a non-contact system that monitors but is not limited to charge current inductive sensing, and/or a thermal monitor(s) that detects excessive charge contact or cable heating as examples. Other sensing is possible (e.g., any other sensing now known or later developed).

In an exemplary embodiment of the cable release and retention mechanism 210, a mechanical release and retention of the charging cable 206 is provided. As discussed above, in an embodiment, the cable release and retention mechanism 210 may include a housing providing a receptacle such as a guide sleeve. And the guide sleeve may include one-way retaining latches on the plug of the charging cable 206 and charging inlet 204A as the first retaining mechanism. Such a retaining mechanism allows simple connection with dual one-way clips that allow insertion using some pressure to overcome spring tension to connect the charge plug of the charging cable 206 to the charging inlet 204A.

An outer one-way clip as a second retaining mechanism retains the charge cable before it connects to the charge inlet 204A and the inner one-way clip (first retaining mechanism) keeps the charging cable connected to the charging inlet 204A as force applied to the charging cable 206 during active charging. The cable release and retention mechanism 210 of the charging inlet 204A could be implemented as retaining mechanisms latches, spring-loaded clip(s), retaining ring(s), or sleeve whose spring pressure, in some embodiments, may be required to be overcome to engage the charge connectors.

In case of a fault, an actuator such as a mechanical actuator, an electrical solenoid or motor, a thermal bimetal, an electrically powered actuator, and/or other mechanism releases the first retaining mechanism (e.g., an inner one-way cable retaining mechanism) such as from instructions from the controller 208. For example, a spring-loaded sleeve could exert enough pressure to physically disconnect the charge contacts and remove the coupled when the first retaining mechanism is released. The second retaining mechanism (e.g., an outer one-way retaining mechanism of the cable release and retention mechanism 210) prevents the charging cable 206 from falling off the apparatus 204 (e.g., the vehicle). In some implementations, a manual lever on the charge connector handle or vehicle lever or other mechanism could release both the inner and outer one-way retaining clips to allow the cable to be removed in normal conditions or release only the outer mechanism in case of a fault event.

In some embodiments, other alternatives could be implemented such as a sleeve or rail with a motorized capture and ejection mechanism. This kind of system would detect the initial insertion of a charge plug to capture and engage the plug. When a fault is detected, the motorized mechanism could eject the plug far enough to electrically disconnect the charge cable but not so far as to release it from the vehicle. In the powered case, a simple release button could be placed on the vehicle or charging connector.

Various embodiments of a charge controller or charging system may use any cable release and retention mechanism 210 now known or later developed. In case of a fault from the charging station 202 or apparatus 204, the controller 208 may cause the charging cable plug to be disconnected but not ejected from the charging inlet 204A to reduce the potential of an energized charging cable 206 from causing a safety issue.

The systems 200 and/or controller 208 may communicate with components of the system (e.g., 202, 204), a user's phone or in-vehicle display, or the charging system and/or charging device itself to allow fault information to be communicated. This can be used to indicate faults to the user of the charging system. Using the same communication methods, the charge controller or charging system could communicate with each other to provide closed-loop fault detection.

Exemplary faults to be detected include, for example: battery overheating, connector overheating, excessive current or voltage, internal charge controller faults, battery module failure, electrical opens or shorts, charge connector resistance or current leakage, charge connector faults, communication failure, external charge controller faults, electrical opens or shorts, charge connector high resistance or current leakage, charge connector faults, communication failure, and/or other faults. One or more of these faults may initiate the cable release and retention mechanism 210 to disengage the charging cable 206. In some implementations, after disengaging the cable, the cable is retained as discussed above.

The apparatus 204 (that is being charged) and/or the charging station 202 may be modified so potentially dangerous fault signals actuate the cable release and retention mechanism 210. In some embodiment, the fault status could also be reported to a user via signal lights, audio alarms, system displays, user devices such as phones or tablets, communication with the charge station, and/or combinations of these methods by the charging system and/or the system being charged. In aspects in which there is an audible alarm, the audio may signal a fault with a change in pitch, volume, and/or speed. Alternatively, the physical disconnect action can notify the user of a fault. The controller 208 may provide these alerts.

FIGS. 3A and 3B are schematic views of a portion of a system 300 operable to perform an electrical charging (e.g., a charging system 300). The system 300 includes a charging inlet (also referred to as a port or socket) 304 and a charging or power plug 302. An exemplary cable release and retention mechanism is provided with the charging inlet 304. The charging system 300 may be substantially similar to a portion of the system 200 (FIG. 2) including the cable release and retention mechanism 210 discussed above. The charging plug 302 may be provided on a charging cable such as the charging cable 206 discussed above. The charging inlet 304 may be provided on a battery or other rechargeable power comprising apparatus such as a vehicle, which may be substantially similar to the apparatus 204 discussed above. As illustrated in FIG. 3A, the charging plug 302 is fully engaged with the charging inlet 304. The engagement provides for physical and electrical coupling between the charging plug 302 and the charging inlet 304, as discussed in further detail below. FIG. 3A is illustrative of a first stage of positioning of the charging plug 302 with respect to the charging inlet 304.

FIGS. 3A and 3B illustrate the cable release and retention mechanism having a receptacle portion 304A (e.g., a sleeve) of the charging inlet 304. A pusher element, here a spring 306, is positioned at the aft region of the inlet 304. Contacts 308 are included in the charging inlet 304. The contacts 308 provide electrical pathways and are dimensionally aligned with the plug 302 for example, providing an interface as discussed in FIG. 1. The cable release and retention mechanism includes a release mechanism (e.g., actuator) 314 that is operably coupled with a first retaining mechanism including clip or latch 310. The release mechanism 314 may be a mechanical actuator, an electrical solenoid or motor, a thermal bimetal, an electrically powered actuator, and/or other suitable release device. A second retaining mechanism is provided by protrusion 312 that extends into the receptacle portion 304A.

The system 300 is but one embodiment of many possible fault disconnect systems and is only provided as an example of the many possible systems that may use any features described herein. Any features described herein may be applied to current and future charge cable and charging system designs. Portions of the system 300 may be applied to an adapter component that is compatible with and can be added to existing charging systems and/or existing systems including a battery to be charged.

### Charge Cable Fully Engaged Stage

FIG. 3A illustrates the charging plug 302 connected physically and electrically with the charging inlet 304. That is, the charging plug 302 is fully engaged with the charging inlet 304.

Insertion of the charging plug 302 occurs when a user or other mechanism pushes the charging plug 302 past the secondary retaining mechanism of the protrusion 312 and overcomes tension of the spring 306 to engage the contacts 308 of the inlet 304. The first retaining mechanism—retention latch 310—retains the plug 302 while in the charging position. The latch 310 is in the locked position in FIG. 3A. That is, the latch 310 is positioned interfacing latch 316 on the charging plug 302 to secure the charging plug 302. While the active charging occurs (e.g., normal charging in a system with no faults), the charging plug 302 may be provided in the stage illustrated in FIG. 3A. Normal release can be done with a mechanical release lever, electrical actuation, or other release system. The retention clip release mechanism, actuator 314, may perform the release. The release mechanism 314 is positioned on a supporting structure 320 that may include a plate. A spring 318 is positioned on the supporting structure and in FIG. 3A is in tension with the inlet 304.

### Charge Cable Ejected and Retained—Not Connected

FIG. 3B is a schematic view of an embodiment the charging system 300 of FIG. 3A in the following state: inlet release actuated, plug retained. In an embodiment, the state is initiated by a fault identified in the system. The release mechanism 314 is actuated and latch 310 is disengaged or unlocked. In an embodiment, the release mechanism 314 includes a pin that retracts providing the release of the latch 310. The spring 318 positioned on the supporting structure 320 reduces tension. The release mechanism 314 is illustrated by an actuator, which is exemplary only. Release mechanisms can be mechanical, electrical, thermal or a combination thereof including as discussed above with reference to FIG. 2. FIG. 3B illustrates the disengagement by movement of the latch 310 away from the receptacle portion 304A. In other words, the latch 310 is in an unlocked position. On release of engagement with the charging plug 302, the spring 306 is no longer held in tension causing a force to drive the charging plug 302 away from the contacts 308. In doing so, the contacts 308 are not engaged with the charging plug 302 and no electrical coupling is provided. In other words, the charging plug 302 is electrically isolated from the charging inlet 304.

However, the system 300 is configured to physically retain the charging plug 302 within the environment of the charging inlet (e.g., within a receptacle portion 304A). In an embodiment, the charging plug 302 physically interfaces a surface of the charging inlet 304, but no electrical connection is made. That is, the charging plug 302 is inserted in the receptacle portion 304A, but not engaged with the charging inlet 304. The contacts 308 are not engaged with the charging plug 302 and are isolated from the charging plug 302.

At the retention state illustrated in FIG. 3B, a secondary retaining mechanism secures the charging plug 302. As illustrated, the secondary retaining mechanism is the protrusion 312 that secures the charging plug 302 preventing it from being fully ejected from the charging inlet 304 (e.g., receptacle portion 304A). A user or other mechanism may subsequently push up the secondary retaining mechanism of the protrusion 312 to fully eject the charging plug 302 and its cable from the receptacle portion 304A.

As discussed above, fault monitoring may be performed by various elements of the charging system (e.g., either the charge receiver, charge controller, or both). A report of a risk or fault conditions may trigger the release mechanism 314. Alternatively, detection circuits (operably coupled to a processor as discussed above) can be used in the plug-inlet combination to direct contact and/or non-invasively detect current, temperature and/or voltage or other faults to natively activate the safety release mechanism based on configurable limits without the need to monitor the charge controller or charge receiver. In this case it could be an add-on to existing charging systems.

Stages of Charging Cable Interfacing with Charging Inlet

FIGS. 4A-4F illustrate a sequence of use of a cable release and retention mechanism such as illustrated in FIGS. 2, 3A, and 3B, for engagement of a charging inlet or socket 304 and a plug 302 of a charging cable. FIG. 4A illustrates a charging inlet 304 and a separate plug 302. As discussed above, the charging inlet 304 may be located on an apparatus comprising a battery to be charged (e.g., vehicle). In other embodiments, the charging inlet 304 may be a socket on a charging station. In some embodiments, a user positions the plug 302 in the state of FIG. 4A.

FIG. 4B illustrates the system in the following state: having the plug 302 inserted but not engaged. In an embodiment, the plug 302 interfaces a surface of the charging inlet 304 as shown by the surfaces mated at A. In an embodiment, no electrical coupling is provided between the plug 302 and the inlet 304. That is, the plug 302 is electrically isolated from the charging inlet 304. In some embodiments, a user positions the state of FIG. 4B.

FIG. 4C illustrates the following state: engaged-active charging connection-retention position 1. In an embodiment of FIG. 4C, electrical coupling is provided between the charging plug 302 and the charging inlet 304; the contacts 308 of the inlet 304 having been engaged with the plug 302. In an embodiment, a spring 306 is compressed providing tension on the charging plug 302. In the state of FIG. 4C, the primary retaining mechanism including latch 310 of the cable release and retention mechanism is engaged with the retaining mechanism or latch 316 of the plug 302 securing the plug 302 position for active charging (e.g., the primary retaining mechanism is locked). FIG. 4D illustrates an alternative view of the state illustrated in FIG. 4C. In an embodiment, the state of FIGS. 4C and 4D are reached by a user providing pressure to depress the spring and engage the connection. Electrical connection—and active charging—occurs in the state of FIGS. 4C and 4D.

FIG. 4E illustrates the following state: release—fault. As illustrated in FIG. 4E, the release mechanism 314 is actuated and the primary retaining mechanism of latch 310 is disengaged from the latch 316 of the plug 302 (e.g., the primary retaining mechanism is unlocked). In some embodiments, the system detects a fault that automatically initiates providing the state of FIG. 4E, without user intervention. FIG. 4E is an instantaneous position, which is by the force of the spring 306 that has now been released force the plug 302 to release and position as shown in the subsequent FIG. 4F.

FIG. 4F illustrates the following state: physically retained-charge disconnect-retention position 2. As illustrated in FIG. 4F, the primary retaining mechanism of latch 310 is disengaged from the latch 316 of the plug 302 (e.g., the primary retaining mechanism is unlocked). The contacts of the inlet 304 are not engaged with the plug 302 and the plug 302 is electrically isolated from the charging inlet 304. In some embodiments, the system detects a fault that initiates the state of FIG. 4E automatically, and without user intervention and the release of the primary retaining mechanism generates the separation of FIG. 4F. For example, in some embodiments, a tension in the spring 306 of the inlet 304 pushes the plug 302 away from the inlet 304 causing a separation with the contacts 308. This disengagement of FIG. 4F can be provided without user intervention. At the stage of FIG. 4F, the secondary retention mechanism, here protrusion 312, secures the plug 302 within the receptacle of the inlet 304. In an embodiment, the protrusion 312 interfaces a latch 316 of the plug 302.

The stages of FIGS. 4A-4F may repeat any number of times.

### Fault Sensing

Current automotive charging systems such as J1772 for example have fault detection and communicating messages. In aspects, a CPU system includes a CPU with a CAN port or other port dedicated to the charge system communication port, or a CPU that monitors charge conditions. The CPU will trigger the disengage system when a safety fault is detected. The CPU system will trigger contact disconnect when a safety fault occurs. The CPU system may include a processor such as the controller 208, discussed above with reference to FIG. 2.

The CPU system can be energized from a direct power connection, a long-life battery, charge power inductive pickup, or other methods. Power taken from the charge system may require a rechargeable CPU battery to maintain fault sensing in case of charge power failure.

Faults for triggering the modification of the charging state include 1) electrical isolation of the plug connector (e.g., from a power source of the charging system) and 2) plug connector is retained within the charging receptacle may be sensed by any additional or alternative systems to fault detection and communication standards. For example, faults may be sensed via integrated sensors that may be part of the vehicle or battery system that requires charging, a battery charging station or system, a charging cable, or the like, or added sensors that may be part of a sensing device coupled to an external interface of the vehicle or battery system that requires charging, the battery charging station or system, a charging cable, or the like.

In one embodiment, an added sensing device (e.g., a sensing device coupled to the external interface) may be a mobile device (e.g., a smartphone), or a component thereof, or a component coupled wirelessly, or via a wire, to the mobile device (in this case, the mobile device may relay communications from the coupled component to the vehicle or battery system that requires charging, a battery charging station or system, a charging cable, or the like).

An integrated sensing device or an added sensing device may include one or more sensors to sense a parameter such as temperature, voltage, current, or any other parameter usable to measure, or device, charging function or performance.

### Retrofit or Original Equipment Embodiments

Any of the features described herein may be used in a retrofit subsystem that may be arranged to install into existing battery charging stations or systems, existing charging cables, existing vehicle or battery or rechargeable power comprising systems, and/or any other original equipment. In these embodiments, the retrofit subsystem may utilize a sensing device of the original equipment, a sensing device in communication with the original equipment (e.g., a sensing device of a smartphone coupled to an external interface of the original equipment), and/or may include an integral sensing device for fault detection.

Any of the features described herein may be incorporated into original equipment. For instance, new battery charging stations or systems, new charging cables, new vehicle or battery systems that requires charging, and/or any other new original equipment may be manufactured utilizing any of the features described herein. Alternatively, new original equipment may be manufactured with a dedicated interface for use with a retrofit subsystem or some other optional original equipment. The present disclosure includes a method of installing the cable release and retention mechanism in an apparatus.

### Method of Operation of a Charging System

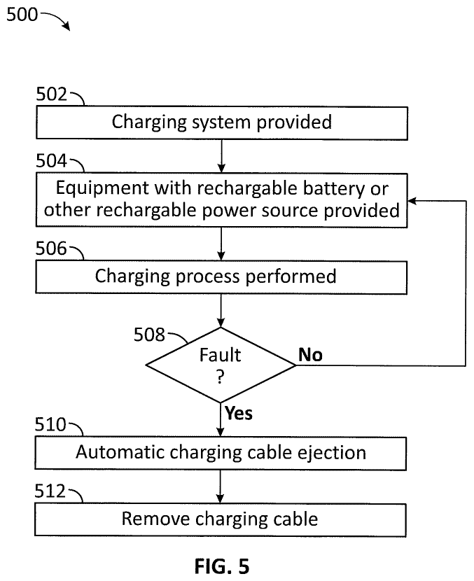

FIG. 5 is illustrative of an embodiment of a method 500 for performing a charging operation using a charging cable release and retention mechanism. The method 500 begins at block 502 where a charging system or station is provided. The charging system may be substantially similar to the charging station 202 discussed above with reference to FIG. 2. In an embodiment, a charging cable extends from the charging system. The charging cable may terminate in a charging plug defined by a charging technique such as those of FIG. 1.

The method 500 continues to block 504 where an apparatus comprising a rechargeable battery or other rechargeable power source is provided. The apparatus may be substantially similar to the apparatus 204 discussed above with reference to FIG. 2. Exemplary apparatuses include electric vehicles such as automobiles, trucks, tractors, construction equipment, power tools, and/or other equipment. The equipment may include a charging inlet (port or socket) for receiving power. The charging inlet may be suitable for the charging technique defined by the charging plug of block 502.

In some implementations, one or more of the systems provided in blocks 502 or 504 include a cable retention and release mechanism. The cable retention and release mechanism may be substantially similar to as discussed above with reference to FIGS. 3A and 3B. The cable retention and release mechanism may include a receptacle for holding the charging cable plug, a first retaining mechanism for holding the charging plug in a first, engaged, position and a second retaining mechanism for holding the charging plug in a second, not electrically engaged, position.

The method 500 proceeds to block 506 where a charging process is performed. The charging process includes coupling the charging inlet of the apparatus of block 504 and the charging cable plug of the system of block 502 to deliver an electrical charge to the rechargeable battery or other power source of the apparatus of block 504. In some implementations, a user may position the plug such that it is fully engaged, electrically and physically connected, with the inlet. Block 506 provides for active charging while monitoring the charging systems for faults. The monitoring may be performed by either the system of block 502, the apparatus of block 504, and/or another controller.

In an embodiment of the method 500, in a block 508, a fault is detected during the active charging of block 506. The fault may be an overcurrent condition, an overvoltage condition, an overheating condition, and/or other faults causing a risk to the system.

On detection of a fault, in block 510, the charging cable is automatically ejected from the charging inlet. An automatic cable ejection mechanism such as the actuator and primary retaining mechanism of FIGS. 3A and 3B may be used to physically disconnect the charging cable plug from the charging inlet. When physically disconnected, the electrical coupling between the systems may be stopped. In other words, the active charging stops and the charging inlet electrically isolated from the charging plug. A finding of a fault in block 508 may also generate an alert to a user.

In an embodiment of the method 500, in block 510 after automatic disconnection of the cable, a secondary retaining mechanism may retain the cable and the plug adjacent the charging inlet. In some implementations, the cable is retained in a receptacle such as a sleeve extending in the charging inlet. The retention allows the cable to be guarded from contact with users or surroundings (e.g., ground). In some implementations, a second retaining mechanism secures the cable within the receptacle.

In block 512, a user may remove the charging cable from the cable retention and release mechanism. In some embodiments, the charging cable is removed from the receptacle such as the sleeve. To remove the charging cable, the user may release a second retaining mechanism. The method 500 may continue to re-engage the charging plug and charging inlet to continue active charging or terminating the charging process.

In view of the many possible embodiments to which the principles of the disclosed technology may be applied, it should be recognized that the illustrated embodiments are only examples and should not be taken as limiting the scope of the disclosure.

What is claimed is:

1. An apparatus usable with an electrical charging system, the apparatus comprising:
a charging inlet operable to receive a charging plug;
a housing extending from the charging inlet and defining a receptacle for the charging plug;
a release mechanism coupled with a first retaining mechanism, the first retaining mechanism being operable to engage the charging plug in the housing in a first state; and
a second retaining mechanism operable to engage the charging plug in the housing in a second state, wherein the first state is electrically connected to the charging inlet and the second state is electrically isolated from the charging inlet.

2. The apparatus of claim 1, wherein the release mechanism is an actuator.

3. The apparatus of claim 2, wherein the first retaining mechanism is a latch.

4. The apparatus of claim 3, wherein the actuator provides moving the latch between a lock position and an unlock position, and, when the latch is in the lock position, the charging plug is in the first state and, when the latch is in the unlock position, the charging plug is the second state.

5. The apparatus of claim 3, wherein the second retaining mechanism is a protrusion extending into the housing.

6. The apparatus of claim 2, further comprising:
a controller operably coupled to the release mechanism of the actuator.

7. The apparatus of claim 1, wherein the charging inlet is positioned on a vehicle comprising a rechargeable battery, the rechargeable battery is electrically coupled to the charging inlet.

8. The apparatus of claim 1, wherein, when in the first state, the charging plug is disposed further within the receptacle than when in the second state.

9. The apparatus of claim 1, further comprising: a spring disposed adjacent the receptacle operable to move the charging plug from the first state to the second state.

10. An electric vehicle, comprising:
a rechargeable battery;
a charging inlet operable to receive a charging plug, the charging inlet including contacts dimensionally arranged to electrically couple the charging plug and the rechargeable battery;
a receptacle extending from the charging inlet and operable receive the charging plug;
an actuator operably coupled to a first retaining mechanism of a latch at a first position along the receptacle; and
a second retaining mechanism at a second position along the receptacle, the second retaining mechanism being disposed further from the contacts than the first retaining mechanism.

11. The electric vehicle of claim 10, further comprising:
a fault detection mechanism operably coupled to the actuator.

12. The electric vehicle of claim 11, wherein the actuator is configured to move the latch between a lock position and an unlock position in response to a fault detected by the fault detection mechanism.

13. The electric vehicle of claim 10, wherein the actuator comprises a mechanical actuator, a solenoid, or a thermal bimetal.

14. The electric vehicle of claim 10, wherein the second retaining mechanism is a protrusion extending into the receptacle.

15. A method for charging equipment, the method comprising:
receiving a charging cable configured to transmit electrical power from an external power source;
connecting the charging cable to a charging inlet mounted on the equipment and configured to couple with a plug of the charging cable;
monitoring, during an active charging session of an electrical pathway between the charging cable and the charging inlet, for a fault condition; and
in response to detecting a fault condition, automatically initiating a disconnect of the charging cable from the charging inlet.

16. The method of claim 15, wherein the fault condition includes at least one of an overcurrent, an overvoltage, or an overheating.

17. The method of claim 15, wherein the automatically initiating the disconnect includes electrically isolating the charging cable from the charging inlet.

18. The method of claim 17, wherein the disconnect includes mechanically disengaging the charging cable from the charging inlet.

19. The method of claim 18, further comprising: after mechanically disengaging the charging cable from the charging inlet, retaining the charging cable adjacent the charging inlet.

20. The method of claim 19, further comprising: manually removing the retained charging cable.
